(19) United States
(12) Patent Application Publication
(10) Pub. No.: US 2019/0380302 A1
(43) Pub. Date: Dec. 19, 2019

(54) ANIMAL FEEDER

(71) Applicant: Doskocil Manufacturing Company, Inc, Arlington, TX (US)

(72) Inventor: Melaney NORTHROP, Mansfield, TX (US)

(21) Appl. No.: 16/399,270

(22) Filed: Apr. 30, 2019

Related U.S. Application Data
(60) Provisional application No. 62/686,342, filed on Jun. 18, 2018.

(51) Int. Cl. A01K 5/01

(52) U.S. Cl. CPC A01K 5/0114

(57) ABSTRACT

An animal feeder includes a feeder body. The feeder body includes an upper surface, a first reception chamber and a second reception chamber. The upper surface has a first opening with a first configuration and a second opening with a second configuration different from the first configuration. The first reception chamber is defined by a first continuous side wall and a first bottom surface, the first reception chamber being connected to the upper surface at the first opening such that the first opening enables access into the first reception chamber. The second reception chamber is defined by a second continuous side wall and a second bottom surface, the second reception chamber being connected to the upper surface at the second opening such that the second opening enables access into the second reception chamber.

### CROSS REFERENCE TO RELATED APPLICATIONS

This application claims priority to U.S. Provisional Application No. 62/686,342, filed Jun. 18, 2018, the contents of which are hereby incorporated by reference.

### BACKGROUND

### Field of the Invention

The present invention relates to animal feeders. In particular, the present invention relates to animal feeders that increase feeding time.

### BACKGROUND OF THE INVENTION

Conventional animal feeders are typically feeding bowls. Other types of animal feeders exist such as slow feeders that block an animal's access to the food.

### SUMMARY

It has been discovered that conventional animal feeders are not desirous for some animals. In particular, it has been found that some animals eat fast, which results in the animal failing to properly chew their food. Additionally, eating fats can result in health problems, such as obesity, gastric dilatation-volvulus (GVD), and poor digestion.

Obesity is a common problem among some animals. For example, 54% of dogs are classified as obese, based on a 2017 report from the Association for Pet Obesity Prevention. GVD is caused when the stomach of a dog is overstretched and is rotated by excessive gas content. GVD can cause shock and result in death. Poor digestion can cause choking, gagging, vomiting, diarrhea, excess gas and other issues.

Additionally, in some animals fast eating can cause aggressive behavior. It has been found that such aggressive behavior can be linked or attributed to a submissive part, being food deprived in the past or simply a desire to eat more. If this behavior is unchecked or not controlled, the animal may develop serious aggression issues and strike out to other pets or owners.

It has been found that many conventional slow feeders do not work and actually cause an increase in aggressive behavior based on the configuration. Additionally, many conventional feeders can be easily tipped or overturned, and are messy and difficult to clean.

Thus, it has been found that an improved animal feeder is desired. In view of the state of the known technology, one aspect of the present disclosure is to provide an animal feeder comprises a feeder body. The feeder body includes an upper surface, a first reception chamber and a second reception chamber. The upper surface has a first opening with a first configuration and a second opening with a second configuration different from the first configuration. The first reception chamber is defined by a first continuous side wall and a first bottom surface, the first reception chamber being connected to the upper surface at the first opening such that the first opening enables access into the first reception chamber. The second reception chamber is defined by a second continuous side wall and a second bottom surface, the second reception chamber being connected to the upper surface at the second opening such that the second opening enables access into the second reception chamber.

Another aspect of the present invention is directed to a method of feeding an animal, the method comprising providing a feeder body including an upper surface, the upper surface having a first opening with a first configuration and a second opening with a second configuration different from the first configuration, a first reception chamber being defined by a first continuous side wall and a first bottom surface, the first reception chamber being connected to the upper surface at the first opening such that the first opening enables access into the first reception chamber, and a second reception chamber being defined by a second continuous side wall and a second bottom surface, the second reception chamber being connected to the upper surface at the second opening such that the second opening enables access into the second reception chamber, and placing animal food in the first and second reception chambers.

Embodiments of the present invention can reduce or prevent health problems, such as obesity, gastric dilatation-volvulus (GVD), and poor digestion.

### BRIEF DESCRIPTION OF THE DRAWINGS

The invention will be explained in more detail hereinafter with reference to the drawings.

FIG. 1 is a top perspective view of an animal feeder according to an embodiment of the present invention;

FIG. 2 is a bottom perspective view of the animal feeder of FIG. 1;

FIG. 3 is a top plan view of the animal feeder of FIG. 1;

FIG. 4 is an elevational cross sectional side view taken along lines 4-4 in FIG. 3;

FIG. 5 is perspective cross sectional side view taken along lines 5-5 in FIG. 1;

FIG. 6 is a top perspective view of a second embodiment of the present invention; and

FIG. 7 is a top perspective view of a third embodiment of the present invention.

### DETAILED DESCRIPTION OF THE EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

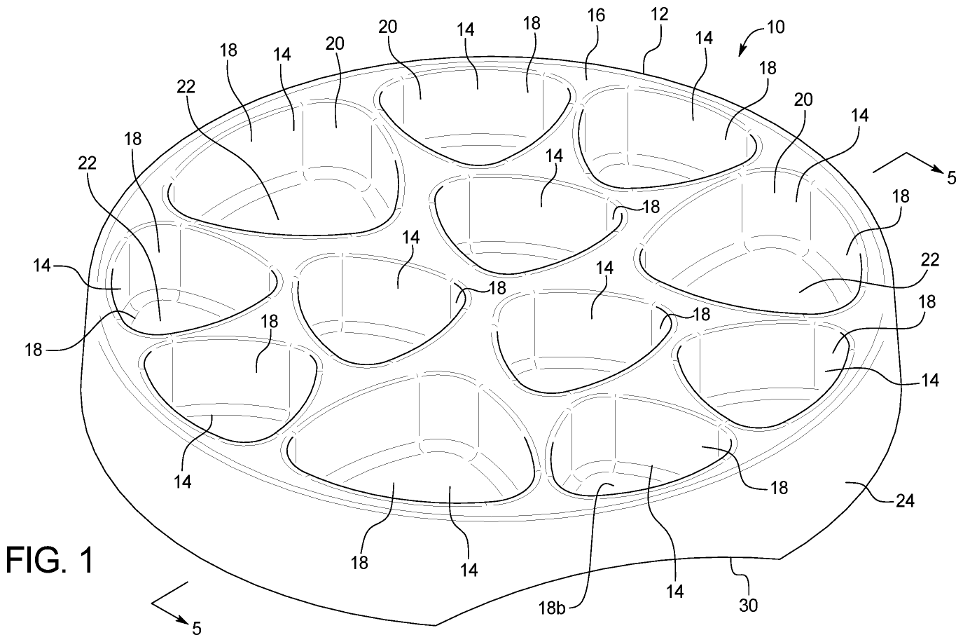

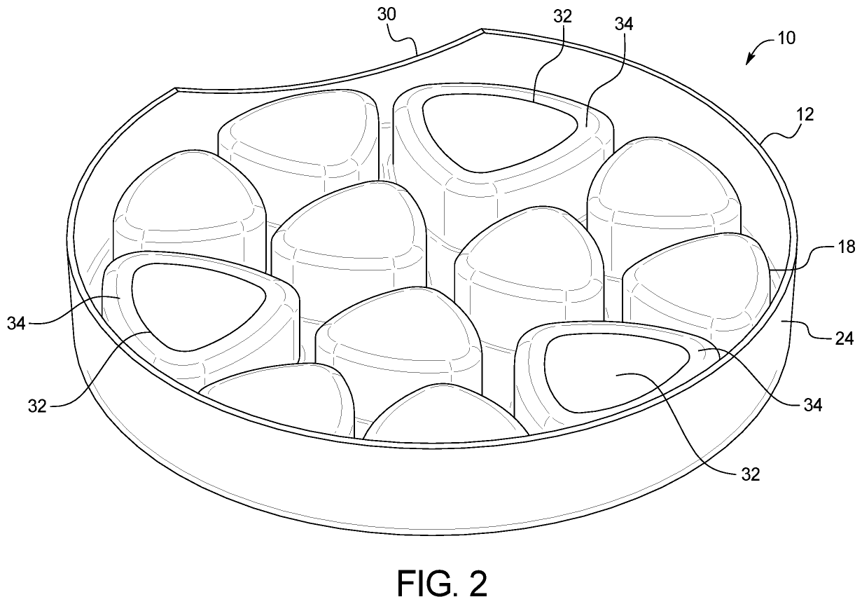

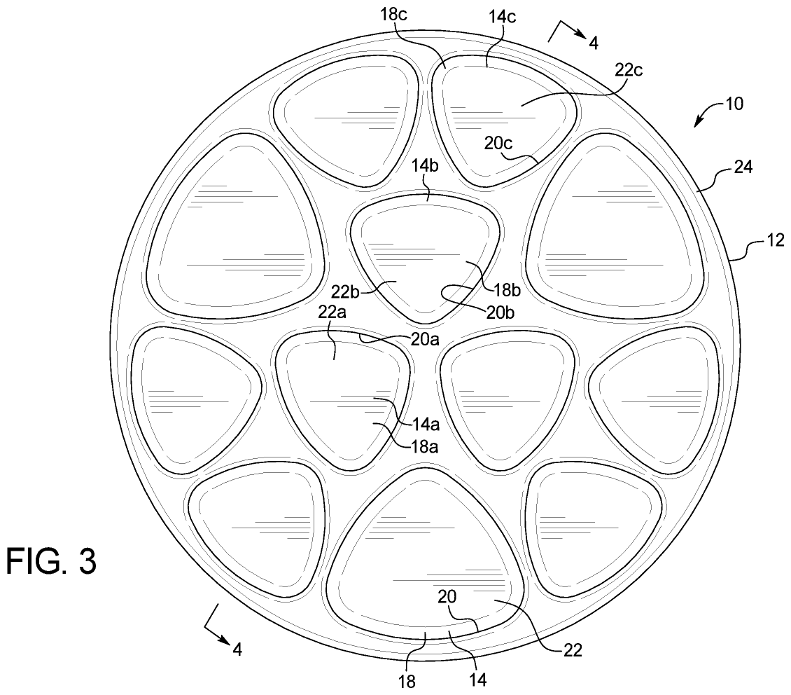

Referring initially to FIGS. 1-5, an animal feeder 10 includes a feeder body 12. The feeder body 12 is preferably a unitarily molded feeder body formed from plastic. However, the feeder body 12 can be formed from any suitable or desirable material and in any suitable manner. The feeder 10 preferably includes a plurality of compartments or reception chambers 14 that are recessed within an upper surface 16 of the feeder body 12. Each of the reception chambers 14 is formed by an opening 18 in the upper surface 16 and a continuous side wall 20 and a bottom surface 22. The reception chambers 14 preferably are unitarily formed with the upper surface 16; however, the upper surface 16 and the reception chambers 14 can be separately formed and intertrally or detachably attached to the upper surface 16 in any suitable manner.

Furthermore, some or all of the reception chambers 14 can be formed from a material different from the upper surface 16 and attached to the upper surface 16. For example, the upper surface 16 can be formed from plastic and some or all of the reception chambers 14 can be formed from metal or vice a versa. In one embodiment, at least one reception chamber 14 is metal and at least one reception chamber 14 is plastic and the upper surface 16 is plastic. However, it is noted that the reception chambers 14 and the upper surface 16 can be formed from any suitable material or materials.

As shown in FIG. 1, the upper surface 16 of the feeder body 12 can include a first opening 18a with a first configuration and a second opening 18b with a second configuration different from the first configuration. In other words, at least two of the openings can have configurations that are a different shape or a different size than the other opening. For example, one opening can be a circle, while another opening is a triangle, an ellipse, a Reuleaux triangular shape, or any other polygonal shape. In one embodiment, two different openings can have the same shape but be different sizes. For example, in one embodiment two of the openings can be circular, but have different diameters. It is noted that the openings 18 can have all the same size and/or shape all the different sizes and/or shape or any combination thereof.

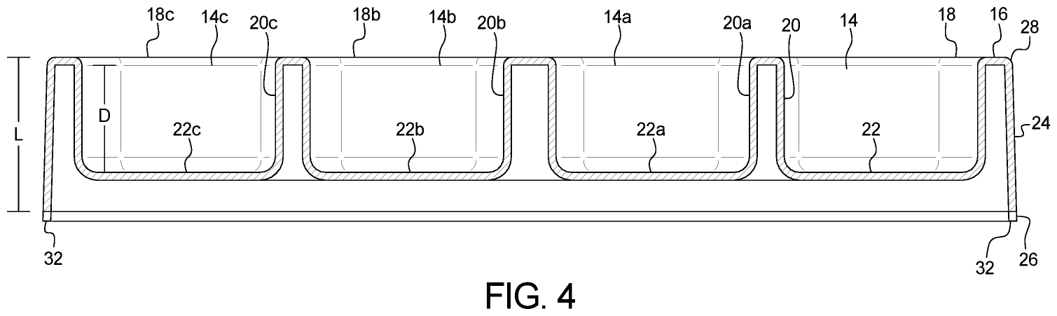

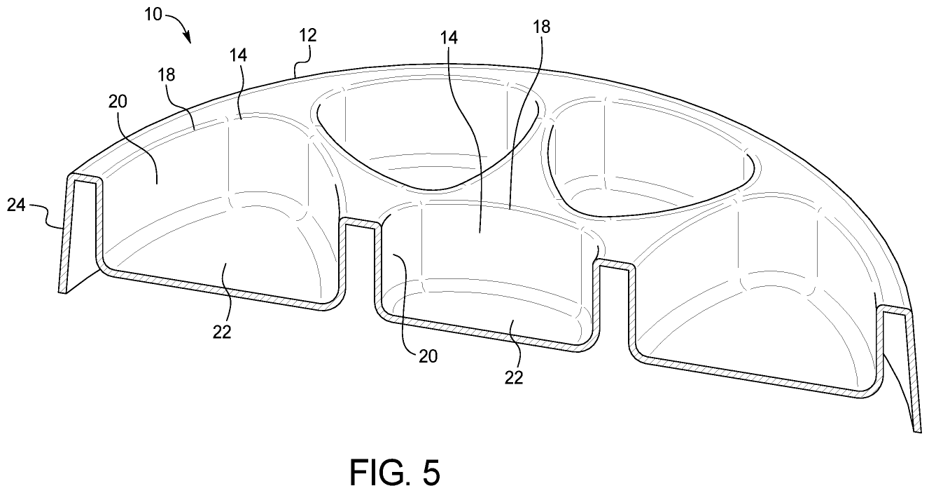

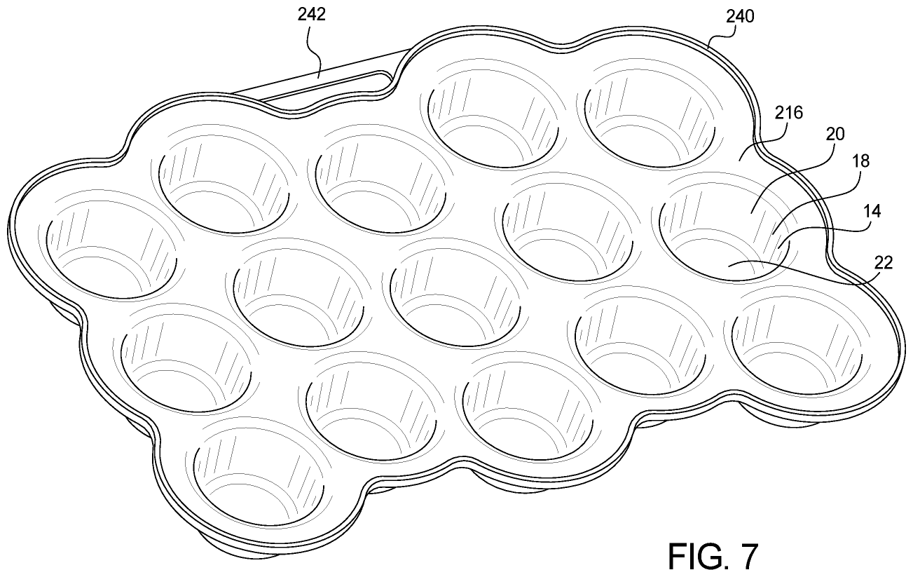

As shown in FIGS. 4 and 5, the plurality of reception chambers 14 can include a first reception chamber 14a and a second reception chamber 14b. The first reception chamber 14a is defined by a first continuous side wall 20a and a first bottom surface 22a, the first reception chamber 14a being connected to the upper surface 16 at the first opening 18a such that the first opening 18a enables access into the first reception chamber 14a. The second reception chamber 14b is defined by a second opening 18b, a second continuous side wall 20b and a second bottom surface 22b, the second reception chamber 14b being connected to the upper surface 16 at the second opening 18b such that the second opening 18b enables access into the second reception chamber 14. As illustrated in this embodiment, the first and second side walls 20 can be transverse to the upper surface 16. That is, the first and second continuous side wall 20 can form a right angle or a non-right angle with the upper surface 16. As illustrated, the side continuous walls 20 extend such that the diameter of the receptions chambers is generally the same from the opening 18 to the bottom surface 22. Thus, as can be understood, the circumference of the bottom surface 22 is about the same as the circumference of the opening 18. However, it is noted that in some embodiments the side continuous walls 20 extend such that the diameter of the receptions chambers reduces from the opening 18 to the bottom surface 22. Thus, as can be understood in this embodiment, the circumference of the bottom surface 22 is less than the circumference of the opening 18. See for example, FIG. 7. In some embodiments the configuration of the circumference of the bottom surface 22 is congruent to or the same as the configuration of the circumference of the openings 18. However, it is noted that the continuous side walls 20 can form a right angle, an acute angle, an obtuse angle or any suitable angle with the upper surface 16, and the bottom surface 22 can have a different shape than the opening 18.

Moreover, the height of each of the continuous side walls 20 preferably is the same resulting in a uniform depth of the reception chambers 14. However, the heights can vary between each of the continuous side walls 20. That is, each continuous side walls 20 can have a different height or the same height or any combination thereof.

In one embodiment, the feeder body 12 includes a third reception chamber 14c. The third reception chamber 14c is defined by a third opening 18c, a third continuous side 20c wall and a third bottom surface 22c. The third reception chamber 14c is connected to the upper surface 16 at the third opening 18c such that the third opening 18c enables access into the third reception chamber 14c. The third opening 18c can be a first distance from the first opening 18a and a second distance from the second opening 18b, the first and second distances being different. Due to the spacing of the openings 18, the feeder 10 can have an overall size that is larger than conventional feeders; however, the feeder 10 can have any desired size. Additionally, the feeder 10 can be sized and the reception chambers 14 can be spaced such that the feeder 10 is configured to feed multiple animals.

In some embodiments the feeder body 12 includes an outer circumferential wall 24. The outer circumferential wall 24 can extend from the upper surface 16 to a distal edge 26. In one embodiment, the outer circumferential wall 24 can form a rounded edge 28 with the upper surface 16 to reduce any sharp or dangerous. The distal edge 26 preferably contacts the surface on which the feeder 10 sits. That is, the circumferential wall 24 is at least the same length L (and preferably longer) that the depth D of the reception chambers. The circumferential wall 24 can add stability to the feeder body 12. However, it is noted that the outer circumferential wall 24 can be shorter than the depth of the receptions chambers or be any suitable or desired length. The outer circumferential wall 24 can include an opening or a recess 30 to facilitate handling or picking up of the feeder 10.

In one embodiment a gripping surface 32 can be applied to distal edge 26 of the outer circumferential wall 24 or the bottom external surface 34 of the feeder body 12. The gripping surface 32 can be a gripping material applied to the outer circumferential wall 24 or the bottom external surface 34 of the feeder body 12 or these areas can be textured or form a gripping surface 32 in any suitable manner. The gripping surface improves gripping of the feeder 10 and reduces or eliminates movement of the feeder 10.

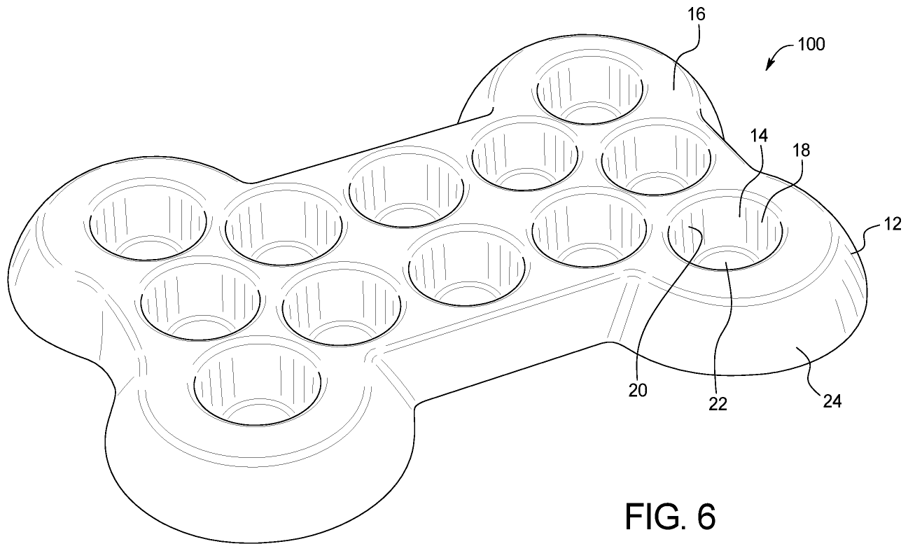

FIGS. 6 and 7 illustrate second and third embodiments of the feeder 100 and 200, respectively. Thus, as can be understood, the feeders 100 and 200 illustrate additional designs and shapes. For example, in the second embodiment, the feeder 100 can be in the shape of a bone or any other shape. Additionally, in the third embodiment, the feeder 200 can have a tray shape with an upper surface 216 that includes an upward extending circumferential lip 240 that is configured to reduce or eliminate food from being pushed off of the upper surface 216. In one embodiment, the upper surface 216 is domed upward to facilitate filling of the reception chambers. In one embodiment, the feeder 200 includes a handle 242 to facilitate picking up of the feeder 200. It is noted that any features of any of the embodiments can be combined. For example, the shape of the feeder or the configuration of the receptacles or the lip of the third embodiment can be combined with the first embodiment.

To feed an animal, first the feeder body 12 is provided. As discussed above, the feeder body 12 can include an upper surface, the upper surface having a first opening 18a with a first configuration and a second opening 18b with a second configuration different from the first configuration, a first reception chamber 14a being defined by a first continuous side wall 20 and a first bottom surface 22a, the first reception chamber 14a being connected to the upper surface at the first opening 18a such that the first opening 18a enables access into the first reception chamber 14a, and a second reception chamber 14b being defined by a second continuous side wall 20b and a second bottom surface 22b, the second reception chamber 14b being connected to the upper surface at the second opening 18b such that the second opening 18b enables access into the second reception chamber 14b. Next animal food is placed in the first and second reception chambers 14a and 14b, and any additional reception chambers if present. If desired the reception chambers 14 can be filled with differing types and/or flavors of food and/or water or any combination of food and liquids.

Thus, when eating, the animal must eat some or all of the food in the first reception chamber, 14a and then move to the next (second) reception chamber 14b. It has been found that this configuration of the feeder 10 increases the animal feeding time. Accordingly, embodiments of the present invention can reduce or prevent health problems, such as obesity, gastric dilatation-volvulus (GVD), and poor digestion. Moreover, the present invention reduces aggressive behavior during eating and leads to a more relaxed posture and better eating mannerisms.

In understanding the scope of the present invention, the term “comprising” and its derivatives, as used herein, are intended to be open ended terms that specify the presence of the stated features, elements, components, groups, and/or steps, but do not exclude the presence of other unstated features, elements, components, groups, integers and/or steps. The foregoing also applies to words having similar meanings such as the terms, “including”, “having” and their derivatives. Also, the terms “part,” “section,” or “element” when used in the singular can have the dual meaning of a single part or a plurality of parts. Accordingly, these terms, as utilized to describe the present invention should be interpreted relative to an animal feeder.

The term “configured” as used herein to describe a component, section or part of a device includes hardware and/or software that is constructed and/or programmed to carry out the desired function.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents.

What is claimed is:

1. An animal feeder, comprising:
a feeder body including
an upper surface, the upper surface having a first opening with a first configuration and a second opening with a second configuration different from the first configuration,
a first reception chamber being defined by a first continuous side wall and a first bottom surface, the first reception chamber being connected to the upper surface at the first opening such that the first opening enables access into the first reception chamber, and
a second reception chamber being defined by a second continuous side wall and a second bottom surface, the second reception chamber being connected to the upper surface at the second opening such that the second opening enables access into the second reception chamber.

2. The animal feeder of claim 1, wherein
the feeder body includes an outer circumferential wall.

3. The animal feeder of claim 1, wherein
the first bottom surface having a similar configuration to the first opening.

4. The animal feeder of claim 1, wherein
the first continuous side wall forms a non-right angle with the upper surface.

5. The animal feeder of claim 1, wherein
the feeder body includes a third opening, the third opening being a first distance from the first opening and a second distance from the second opening, the first and second distances being different.

6. The animal feeder of claim 5, further comprising
a third reception chamber being defined by a third continuous side wall and a third bottom surface, the third reception chamber being connected to the upper surface at the third opening such that the third opening enables access into the third reception chamber.

7. The animal feeder of claim 1, wherein
the feeder body includes a bottom external surface with a gripping surface.

8. The animal feeder of claim 1, wherein
the feeder body has a bone shape.

9. The animal feeder of claim 1, wherein
the first opening has a generally Reuleaux triangular shape.

10. The animal feeder of claim 1, wherein
the first continuous side wall has a first height and the second continuous side wall has a second height, the first height being different from the second height.

11. A method of feeding an animal, the method comprising:
providing a feeder body including an upper surface, the upper surface having a first opening with a first configuration and a second opening with a second configuration different from the first configuration, a first reception chamber being defined by a first continuous side wall and a first bottom surface, the first reception chamber being connected to the upper surface at the first opening such that the first opening enables access into the first reception chamber, and a second reception chamber being defined by a second continuous side wall and a second bottom surface, the second reception chamber being connected to the upper surface at the second opening such that the second opening enables access into the second reception chamber; and
placing animal food in the first and second reception chambers.

12. The method of claim 11, wherein
the providing the feeder body includes providing the feeder body with third opening, the third opening being a first distance from the first opening and a second distance from the second opening, the first and second distances being different.
